(19) United States
(12) Patent Application Publication
(10) Pub. No.: US 2006/0074809 A1
(43) Pub. Date: Apr. 6, 2006

(54) Usage data collection system and method

(76) Inventor: Barry D. Meyer, Austin, TX (US)

Correspondence Address: H. DALE LANGLEY, JR.;THE LAW FIRM OF H. DALE LANGLEY, JR. PC, 610 WEST LYNN, AUSTIN, TX, 78703, US

(21) Appl. No.: 10/950,264

(22) Filed: Sep. 24, 2004

(51) Int. Cl. G06Q 99/00; G06F 9/44; G06F 15/173

(52) U.S. Cl. 705/52; 705/7; 709/223

(57) ABSTRACT

A system for collecting use data of a device includes an agent of the device and an administrator for the device. A communications network, such as the Internet or other network, connects the agent and the administrator. The agent hooks an operating system of the device and detects use data of the device. The agent via the device communicates the use data of the device to the administrator over the network. A cache of the device is shared by the agent and the operating system of the device, and is accessed by the agent to obtain the use data hooked by the agent. The agent can accumulate the use data for the device in a log of the device. The agent communicates the logged use data, either at programmed or pre-set times or on request for use data from the device by the administrator.

### BACKGROUND OF THE INVENTION

The present invention generally relates to communications network management systems and methods and, more particularly, relates to usage data collection systems and methods for system management of communications networks, such as, for example, computer and device networks of a company or enterprise.

In communications networks, administrators of the networks often want or need to determine usage data and information regarding the various elements of the networks. Typically, such networks include, for example, server computers, desktop computers, personal digital assistants, cellular phone/processing devices, peripherals such as displays, input devices, media devices, storage, printers and others, and a multitude of other possible networked or networkable devices. The networked devices in these communications networks can be interconnected by wire, wireless, and other communication links. The various devices can be local, such as within a single office or building, or, as is often the case, are widely distributed throughout several geographic regions. Devices can even be located internationally, can be fixed or mobile in location, and can otherwise be widespread and diverse in location and communicative operations.

There are a variety of protocols and technologies employed in communications networks. Currently, a predominant networking technology operates in accordance with Transmission Control Protocol/Internet Protocol (TCP/IP). The public Internet also operates in accordance with TCP/IP protocols and technologies. Communications networks operating in accordance with TCP/IP, therefore, can include communicative elements located in virtually any and all geographic locations where the Internet is available. Such widespread communicative elements of communications networks makes administration and supervision of operations of the entire networks, and the various elements thereof.

It would be a significant improvement in the art and technology to provide maintenance and administration systems and methods for communications networks, and particularly, to incorporate usage data detection, collection, and determination features for disparate devices of such networks. Additionally, it would be a significant improvement to automate the usage data detection, collection and determination and to provide ease of management and administration for such data. Moreover, it would be a significant improvement in the art and technology to provide usage data features to network administration systems and methods for widespread and disparate networks, including Internet, intranet and enterprise connected devices. The present invention provides numerous advantages and improvements, including, for example, usage data detection, collection and determination for widespread networks of communication devices, including connected computers and other devices.

### SUMMARY OF THE INVENTION

An embodiment of the invention is a system for collecting use data of a device. The system includes an agent of the device, an administrator for the device, and a network communicatively connected to the agent and the administrator. The agent communicates the use data of the device to the administrator over the network.

Another embodiment of the invention is a system for collecting usage data. The system includes a client, a server, an administrator and a communications network communicatively connected to and between the client, the server and the administrator.

Yet another embodiment of the invention is a method of collecting use data for a client device. The use data is communicated to an administrator device over a network.

The method includes hooking an operating system of the client device to obtain a use data, and pushing the use data to the administrator device by communication over the network.

### BRIEF DESCRIPTION OF THE DRAWINGS

The present invention is illustrated by way of example and not limitation in the accompanying figures, in which like references indicate similar elements, and in which:

FIG. 1 illustrates a use data collection system, including multiple client devices and a communications network, such as the Internet, for communicating usage indicia of the client devices over the network to a server computer, according to certain embodiments;

FIG. 2 illustrates a client computer including an agent for obtaining use data of the client computer and an administrator computer including an administrator application for handling use data, the client computer and the administrator computer being communicatively connected by a network, according to certain embodiments;

FIG. 3 illustrates a client computer including an operating system, multiple applications programs, a cache memory, and a log memory, and also including an agent for portioning a shared data segment of the cache memory for access by the operating system and the agent, the agent hooking the operating system to provide use data to the shared data segment, accessing and logging the use data, and communicating the use data as logged, according to certain embodiments;

FIG. 4 illustrates an agent of a client computer, the agent including an operating system hook element, a log element and a push- element, each such element communicatively connected to obtain, accumulate and send use data for the client computer over a network to an administrator, according to certain embodiments;

FIG. 5 illustrates a network collector system including two client devices, a server and connected database, and two administrator devices, communicatively interconnected by a network for usage data collection corresponding to use and operations of the client devices, according to certain embodiments; and

FIG. 6 illustrates a method of collecting use data of a device, via an agent operation of the device including hooking, logging and pushing, and possible inputs to the method for controlling the method and handling of collecting use data, according to certain embodiments of the invention.

### DETAILED DESCRIPTION

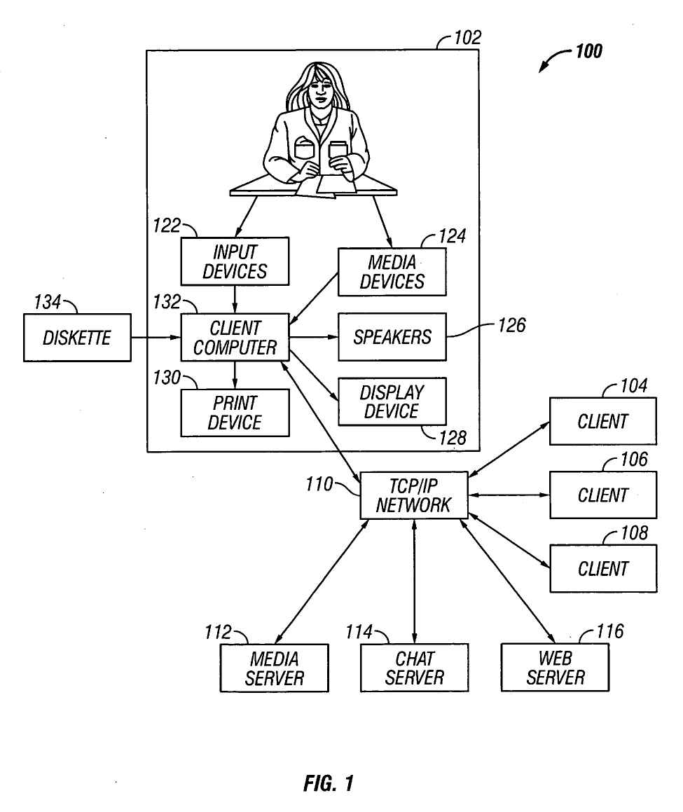

Referring to FIG. 1, a computer network management system 100 includes a communications network 110, such as a Transmission Control Protocol/Internet Protocol (TCP/IP) or other networking protocol-based network. The network 110 communicatively connects servers 112, 114 and 116 to each of clients 102, 104, 106 and 108. Through the network 110, data is communicable by and between the servers 112, 114 and 116, and the clients 102, 104, 106 and 108, each to the other. The network 110 comprises wired, wireless, optical, Wi-Fi, WAN, LAN, any other possible communicative connections, channels, or links, and single ones or combinations thereof.

The clients 102, 104, 106 and 108 are substantially identical in that each is capable of communicative connection to and with the network 110, in at least one of any of the various possible communicative connections of and to the network 110. For example, clients can be any of a personal or desktop computer, notebook computer, personal digital assistant, cellular telephone, or any of a variety of other communicative or processing devices or systems of such devices. The client 102 is representative of each of the clients 102, 104, 106 and 108, for purposes of the description herein.

The client 102 includes, for example, a communicative component (e.g., a modem, a network card, a cellular link, an 802.11 link, or any other communicative link to the network 110) for performing transmissions and receptions of data to, from and over the network 110. The client 102 can also have a user 120 of the client 102, such as a human operator or another controlling device or application. The client 102, as is typical, can also include various peripherals and other components, such as, for example, input devices 122, media devices 124, speakers 126, a display device 128, a print device 130, a computer 132, a storage device 134, and other elements and functional components.

In the example of the client 102, the computer 132 is connected to the input devices 122, the media devices 124, the speakers 126, the display device 128, the print device 130, and the storage device 134. The display device 128 is, for example, a conventional electronic cathode ray tube, a flat-panel display, a separate computer or device, and any other of a wide possibility of components and elements that permit display either to the user 120 or to another device or application, as the case may be. The print device 130 is, for example, a conventional electronic printer or plotter. The storage device 134 is, for example, a hard drive, RAM, ROM, or any other digital or analog storage system or device.

In operation, the user 120 operates and controls the operations of the computer 132. For example, in response to signals from the computer 132, the display device 128 displays visual images, and the user 120 views such visual images. Also, in response to signals from the computer 132, the print device 130 can print visual images on paper, and the user 120 views such visual images. Further, in response to signals from the computer 132, the speakers 126 can output audio frequencies, and the user 120 listens to such audio frequencies. Moreover, the user 120 operates the input devices 122 and the media devices 124 in order to input information to the computer 132, and the computer 132 receives such information from the input devices 122 and the media devices 124.

The input devices 122 include, for example, a conventional electronic keyboard and a pointing device such as a conventional electronic “mouse”, rollerball, light pen, or other input function element. The user 120 operates the keyboard to input alphanumeric text information or other function or input information to the computer 132, and the computer 132 receives such information from the keyboard as so input. The user 120 further operates the pointing device to output cursor-control information to the computer 132, and the computer 132 receives such cursor-control information from the pointing device.

The user 120 operates the media devices 124 in order to output information to and output information from the computer 132 in the form of media signals, and the computer 132 receives or outputs such media signals to and from the media devices 124. The media signals include, for example, video signals and audio signals. The media devices 124 include, for example, a microphone, a video camera, a videocassette player, a CD-ROM (compact disc, read-only memory) player, a DVD (digital video) player, an electronic scanner device, and any other of a wide variety of possible input and output devices for media use and viewing/reception.

A network communications application, such as, for example, a web browser software application of the computer 132, is connected, via the client 102, to the network 110. For example, the client 102 is connected directly to the network 110, or through a local area network (LAN), a wide area network (WAN), or other communicative link, e.g., the communicative link can itself include various communicative links and connections including other networks or channels for connectivity. Via communicative connectivity to and from the network 110, the client 102 can transmit and receive from the network 110, for example, over the Internet, the World Wide Web (WWW), or other vehicle, protocol, standard, or proprietary mechanism.

Various other communicative devices and elements in addition to the client 102 are communicatively connected to and with the network 110, for communications to and from the client 102 over the network 110. Various servers, for example, the media server 112, the chat server 114, and the web server 116, are exemplary of devices connected to the network 110 and communicatively connected or connectable to the client 102. The media server 112, for example, serves media data to the client 102 upon appropriate communications to and from the client 102 and as dictated and enabled by the user 120 of the client 102. Similarly, the chat server 114 enables chat communications between the client 102 and the chat server 114, as dictated and enabled by the user 120 at the client 102. The web server 116 is any of a variety of server elements and communicative devices connected to the network 110, for communications of data and other information to and from the client 102 over the network 110. For example, the web server 116 is a server computer communicatively connected to the network 110 permitting communicative access by the web server 116 to the client 102 over the network 110 and permitting communicative access by the client 102 to the web server 116 over the network 110.

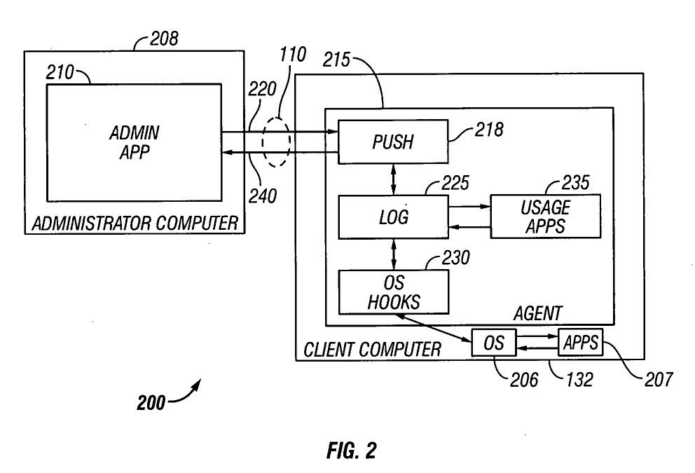

Referring to FIG. 2, a usage data collector 200 of the system 100 of FIG. 1 includes, for example, an administrator computer 208 and an administrator application 210 operable thereon. The 208 and the application 210 communicatively connect to the network 110 for communicative connection to the client 102 over the network 110. The application 210 is, for example, a web browser or other communicative element or application of the computer 208. The computer 208 is, for example, a network server, such as the web server 116 of FIG. 1, or is otherwise communicatively connected via a network server of the network 110, for communicative connectivity of the client 102 over the network 110 to and from the computer 208. Although the application 210 and computer 208 are particularly described here, any other communicative element or application of a communications device can alternatively or additionally be employed in the collector 200, and all such possibilities are included herein. For exemplary purposes, the computer 208 and the application 210 are specifically discussed herein; however, all other communicative devices and applications with similar capabilities and communicative connections are possible in the collector 200.

The application 210 operates on the computer 208 to access and control an agent 215 residing on the computer 132. The computer 132, as previously described, includes an operating system 206, such as, for example, Windows, Linux, Mac OS, or other. The computer 132 also includes various applications 207, such as, for example, an e-mail client, a word processor, a spreadsheet application program, and/or a wide variety of other software and hardware applications and functions.

The agent 215 on the computer 208 is implemented in software, hardware or some combination on the computer 132. The agent 215, as hereinafter more fully described, is capable of communicating within the computer 132 with signals of the computer 132 indicative of operations at the computer 132 of the operating system 206 and the applications 207.

The agent 215 is also communicatively connected, via the network 110, to the application 210 of the computer 208. The agent 215 is installed and stored locally on the computer 132. Alternatively, the agent 215 is installed on a network server communicatively connected to the network 110 (or other network) and thereby communicatively connected to the computer 132; in such instance, the agent 215 is nonetheless executed locally on the computer 132 via the computer 132 accessing the network server and the agent application thereat. As has been mentioned, the computer 132 (of the client 102 of FIG. 1) is exemplary of computers of all other clients 104, 106, and 108 of the network 110. Likewise, the agent 215 is installed on or operable at or by each computer of each client of the network 110, in substantially similar manner. The administrator computer 208, via the application 210, selectively communicatively accesses the agent 215 of the computer 132 (and each other computer of networked clients) over the network 110.

In operation, the administrator computer 208, either through a human user or an application or device, or combination thereof, and the application 210 thereon, communicate 220 to the agent 215 of the computer 132 by typing in a standard Uniform Resource Locator (URL) or by clicking on a URL “link” from a web page. The application 210 makes a request to the agent 215 preferably via HTTP for access. Alternatively, the agent 215 can accept requests using secure HTTP (SHTTP) protocol using Secure Sockets Layer (SSL) or other protocols or communications structures.

The agent 215 includes OS hooks element 230. The OS hooks element 230 communicatively connects to the operating system 206 of the computer 132 or otherwise to signals indicative of operations of the operating system 206 on the computer 132, as hereafter further discussed. The agent 215 also includes a log element 225. The log element 225 is communicatively connected to the OS hooks element 230 of the agent 215. Additionally, the agent 215 includes a push element 218. The push element 218 is communicatively connected to the log element 225 of the agent 215. The push element 218 is also communicatively connected to the network 110 to send and receive communications thereover to and from the administrator computer 208 and the administrator application 210.

Additionally, the agent 215 can include various usage applications 235, for example, a programmable interface, a display function, an analysis function, and any other of a wide variety of functional blocks and elements. The usage applications 235 are communicatively connected to the log element 225 of the agent 215, and also can be communicatively connected to the OS hooks element 230 and/or the push element 218, as applicable and depending on the desired application and functionality.

In operation, the agent 215 hooks into the operating system 206 or into signals or stored data or indicators available from or by the operating system 206. The operating system 206, in connection with operations of the applications 207 on the client computer 132, detects and recognizes various key strokes, inputs, and other signals and operations from or in connection with the existence or operations of the applications 207 at the client computer 132. These operating system 206 indicators because of the applications 207 are detected, identified, and recognized by the OS hooks element 230 of the agent 215. Once recognized by the OS hooks element 230, the log element 225 of the agent 215 retains or stores in memory the indicators or other indicia of the indicators. At request of the administrator application 210 made via communications over the network 110 to the client computer 132 and the agent 215 thereon, the push element 218 of the agent 215 communicates data over the network 110 to the administrator application 210 indicative of the indicators and indicia corresponding to the usage of the client computer 132, including, for example, the status of an application 132, the time of usage of the application 132, or any of a wide variety of other usage information for the application 132 and the client computer 132. Additionally or alternatively, the push element 218 can, based on program settings at the client computer 132, periodically or otherwise initiate communications of such information from the agent 215 at the client computer 132 to the administrator application 210 at the administrator computer 208. All such communications can occur over the network 110.

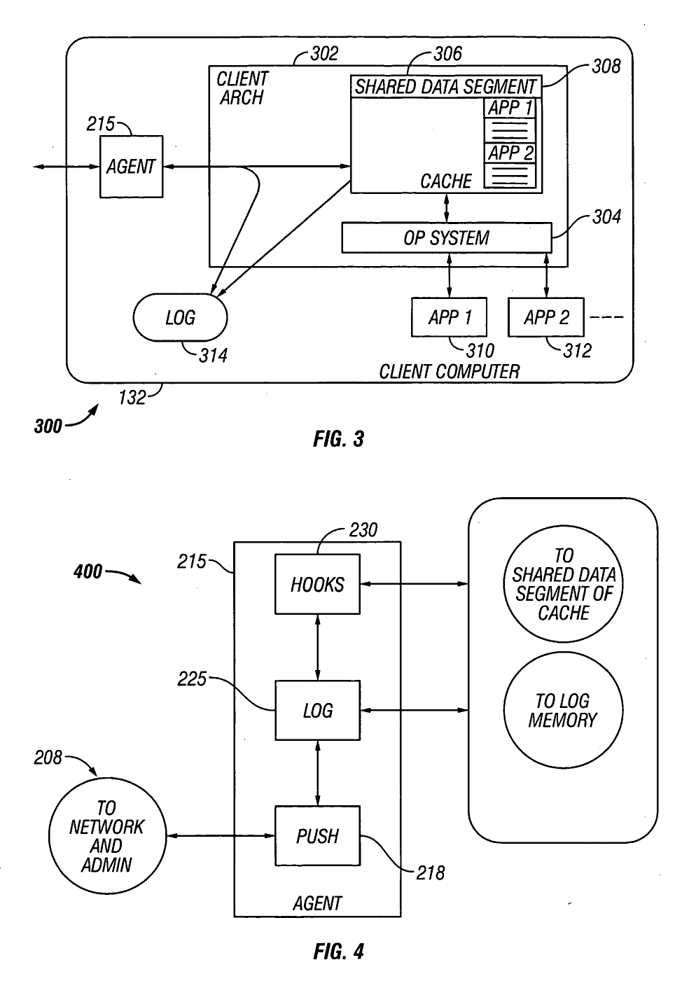

Referring to FIG. 3, a usage agent system 300 at the client computer 132 includes the agent 215 installed on the client computer 132. The client computer 132 includes a client computer architecture 302. The architecture 302 includes a processor and circuit board (each not shown in detail), an operating system 304, and a cache memory 306. The operating system 304 is communicatively connected to the cache memory 306. The agent 215, together with the operating system 304, sets a portion of the cache memory 306, i.e., a shared data segment 308, for shared data usage by the operating system 304 and the agent 215. In operations of the client computer 132, the operating system 304 utilizes the cache memory 306 in running the computer 132, and the shared data segment 308 of the cache memory 306 is employed by the operating system 304 for storage of indicia and information.

Particularly, in conjunction with the operating system 304, a first application program 310 and a second application program 312 are operable on the computer 132. Each of the application programs 310, 312 is implemented at the computer 132 in software, firmware, hardware or in other manner. An example application program 310, 312 is an e-mail client program. As is typical, the e-mail client program is operable on the computer 132, in conjunction with the operating system 304, to permit the client computer 132 to send and receive e-mail messages and to perform other e-mail operations. When one of the application programs 310 or 312 is initiated and run on the computer 132, in conjunction with operations of the operating system 304 on the computer 132, keystrokes, pointer input, interim and final information and data, and other signals and information is input or generated. The operating system 304 handles and controls the operations of the application programs 310, 312 in these and other respects. Because the operating system 304 so handles and controls the application programs 310, 312, the operating system 304 detects, identifies and recognizes various occurrences (including such matters as keystrokes, other inputs, and signals) in operations of the application programs 310, 312.

These various occurrences, or indicators thereof, are saved to the cache memory 306 and, at least certain of the occurrences or indicators are maintained in the shared data segment 308 of the cache memory 306. The agent 215, as well as the operating system 304, accesses the shared data segment 308 and the information from time to time maintained therein. In this manner, the agent 215 detects, identifies, recognizes and can employ usage information indicated by the information stored in the shared data segment 308, as identifiers of usage of the computer 132, including operations of the applications 310, 312 thereon. Although only the two applications programs 310, 312 are shown in FIG. 3, it is intended and to be understood that any type, number and variety of applications can be operable on the computer 132. The agent 215, in every event, similarly reads and can employ the information saved in the shared data segment 308. This information in the shared data segment 308, via the employment by the agent 215, is useable by the agent 215 to communicate usage information regarding the computer 132 and its applications, to another device over a network or communications link (e.g., the agent 215 communicates over the network 110 to and with the administrator computer 208 and the administrator application 210 as described with respect to FIG. 2).

The agent 215 furthermore operates to cause the computer 132 to maintain in memory storage, e.g., in a log memory 314 of the hard disk memory of the computer 132, various of the information over time that the agent 215 detects in the shared data segment 308 of the cache memory 306. The agent 215 compiles and organizes the information in the log memory 314, for periodic and desired transmission and also for purposes of operations of the agent 215. As previously mentioned, the agent 215 can include any of a wide variety of usage applications 235 (shown in FIG. 2) to effect various manipulations, determinations, analyses and other operations on or with the information of the log memory 314 or to derive the information of the log memory 314, all as applicable or desired for the system 300.

Referring to FIG. 4, the agent 215 of FIGS. 1, 2 and 3, of a usage collection system 400 (e.g., like the system 300 of FIG. 3), more particularly includes the OS hooks element 230, the log element 225 and the push element 218. As previously described with respect to FIG. 2, the OS hooks element 230 is communicatively connected to the log element 225, and the log element 225 is communicatively connected to the push element 218. The OS hooks element 230 and the log element 225 are each also communicatively connected to other portions of the client computer, for example, to the shared data segment 308 and to the log memory 314, respectively. The push element 218 is communicatively connected, over the network 110 either directly or through other devices and links, to the administrator computer 208 and the administrator application 210 thereof.

In certain example embodiments of the system 400, the agent 215 includes a dynamic link library (dll) (referred to herein as “swutz.dll”) as the OS hooks element 230. This swutz.dll is system-wide hooks for the operating system 206, 304 (in FIGS. 2 and 3, respectively) of the client computer. These hooks of the swutz.dll are loaded when an application, for example, the applications programs 207 of FIG. 2 and 310, 312 of FIG. 3, is initiated in operations on the client computer. The swutz.dll also sets up the shared data segment 308 of FIG. 3 in the cache memory 306 of the client computer, in order that the information of operations of the applications programs, because of the hooks to the operating system, are saved by the operating system to the shared data segment 308. Thus, the swutz.dll is only invoked to handle data saves to the shared data segment 308 on initiation of the applications program. The agent 215, because of the storage of information on invocation of the applications program and the use of the shared data segment 308, does not unduly or significantly alter or affect operations of the client computer or the applications programs thereon.

In operation of swutz.dll, the dll attaches to the application on start-up of the application. Thereafter, the user-session involving the application is tracked through local internal caching at the client computer. Only user-inputs to the application are thereafter cached at the client computer. In the example embodiment, this tracking also includes indicators of the particular application, the user name/domain of the particular user, and the identity of the device running the application.

At intervals according to programming of the agent 215 and settings of the administrator and client user, the log element 225, in communication with the OS hooks element 230, invokes and executes an executable operation of the agent 215, herein referred to as “swutzlog.exe”. This swutzlog.exe of the log element 225 triggers a log rotation of information maintained in the log memory 314 of FIG. 3 of the computer 132. Each time this log rotation is triggered via swutzlog.exe, the then-contents of the stored data segment 306 of the cache memory 306 of the computer 132 are accessed and saved to the log memory 314. The immediately preceding entry in the log memory 314 from operations of swutzlog.exe are then backed-up and retained in the log memory 314. Additionally, the backed-up entries are placed in an outbox portion of the log memory 314 in preparation for next operations, including delivery of the log entries over the network 110 to the administrator computer 208. The log rotation can be triggered, for example, on the order of once every minute or as otherwise desired.

Then, at periodic intervals according to the programming and settings of the agent 215, and/or on request to the agent 215 from the administrator computer 208 over the network 110, the agent 215 invokes and runs another executable file of the agent 214. The executable file is part of the push element 218 of the agent 215. Herein, the executable is referred to as “mapush.exe”. The periodic intervals for invoking and running mapush.exe of the push element 218 can be, for example, on the order of once every day or as otherwise desired.

The push element 218, via the invocation and running of mapush.exe, sends the then-contents of the outbox portion of the log memory 314 over the network 110. The network 110 conveys the contents to the administrator computer 208 for operations thereat via the administrator application 210. Alternatively, the push element 218 or other aspects of the agent 215 can manipulate, organize, format, analyze or otherwise handle the contents of the outbox portion of the log memory 314 prior to sending the contents or indicia of the contents. Compression, encryption and other handling is possible prior to sending of the contents or indicia of the contents. Moreover, the contents or indicia of the contents, as the case may be, can be employed in analysis or other manipulations, with the results of that analysis or manipulations (in lieu of or in addition to the contents) being the sent information.

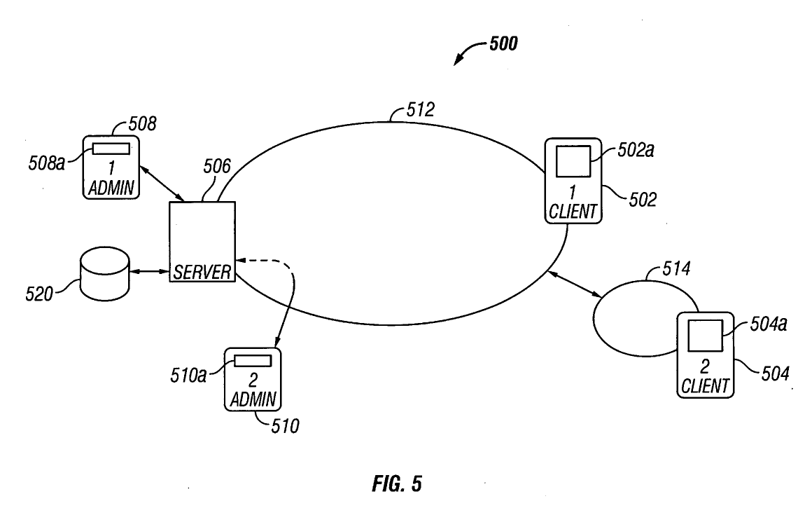

Referring to FIG. 5, a network collector system 500 includes clients 502, 504, communicatively connected to at least one server 506. The server 506 is connected to one or more administrators 508, 510. Each of the clients 502, 504 includes processing and communications elements, and also each includes a microagent 502a, 504a substantially like the agent 215 of the prior Figures. Each of the administrators 508, 510 also includes processing and communications elements, and further includes an admin application 508a, 510a, respectively, substantially like the administrator application 210 of the prior Figures.

The clients 502, 504 are each respectively communicatively connected to the server 506 via a communications network 512, such as the Internet or other communications network. Client 504 is communicatively connected to the network 512 via another communications network 514, such as a LAN, WAN, or other communications connection. Each of the administrators 508, 510 is communicatively connected to the server 506; for example, the administrator 508 is directly communicatively connected to the server 506 by a wired or wireless channel or combination and the administrator 510 is communicatively connected to the server 506 via the network 512 or some other network or connection. Additional and alternative clients, server, and administrators are possible in keeping with the concepts, and those elements and their communicative interconnectivities are intended as exemplary.

The server 506 includes a database 520, or can communicatively access such a database 520. The database is, for example, a relational database, such as an Oracle database.

In operation, as and when an application is run or commenced on one of the clients 502, 504, the respective microagent 502a, 504a of the particular client 502, 504 detects and recognizes the application and inputs to the application. At the client 502, 504, the microagent 502a, 504a operates as described as to the agent 215 in connection with FIGS. 3 and 4. The particular microagent 502a, 504a sends communications of usage data over the network 512 (including via the network 514, if applicable) to the administrators 508, 510, or either of them, via the server 506 or otherwise.

At the server 506 and via the database 520, the usage data is collected for each respective client 502, 504. This usage data is then accessible by the administrators 508, 510, or either of them as applicable. Of course, at the server 506, the server 506 can limit access to particular usage data for respective clients 502, 504, as well as restrict the form and content of that data. Additionally, processing of usage data at the server 506, via the database 520 or other applications (not shown in detail), can manipulate, analyze and further handle the usage data, as desired for the system 500.

Each respective administrator 508, 510, via the respective admin application 508a, 510a, can also limit access or manipulate, handle, analyze or otherwise deal with the usage data. Moreover, the admin applications 508a, 510a can communicate control signals and other information to and between the respective clients 502, 504, for purposes of operations of the respective microagents 502a, 504a or for other purposes.

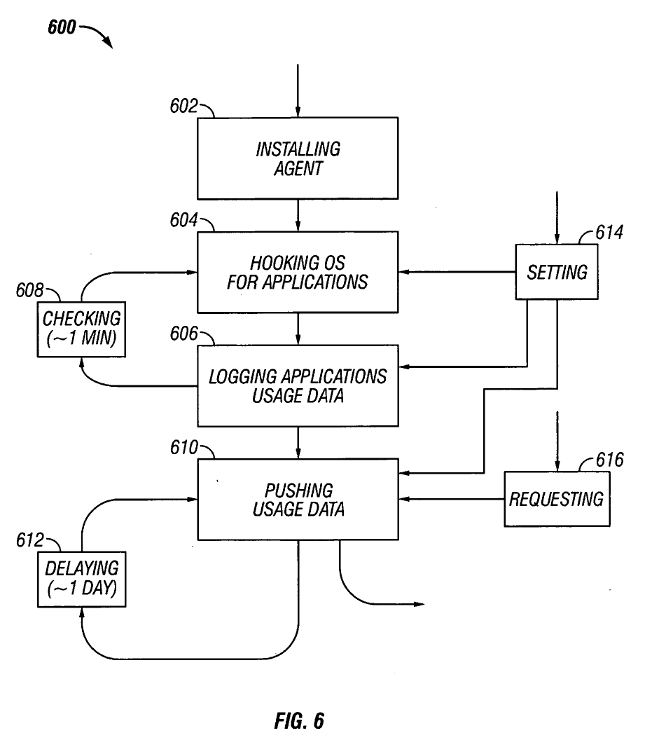

Referring to FIG. 6, a method 600 of the system 500 (and also of the systems of FIGS. 1-4) commences with a step of installing an agent 602, such as the agent 215 or microagent 502a, 504a, on a client device. The client device thereafter operates the agent on the client device. In a step 604, the agent performs hooking of the operating system of the client device in order to detect applications being performed at the client device. As previously, the step 604 of hooking includes portioning a cache of the client device for shared access by the operating system and the agent.

In a step 606, the agent performs logging of applications data usage by the client device. The step 606 of logging includes obtaining from the cache of the client device certain usage indicia saved to the cache via the step 604 of hooking. Whenever any application is operated or performed on the client device, the usage data of the operating system stored in the cache becomes available for logging in the step 606. The step 606 includes obtaining the usage indicia and saving the indicia to a log in memory of the client device. The step 606 also includes backing-up of prior usage indicia in the log, upon each new usage indicia so obtained. The step 606 is repeated in a step of checking 608, at intervals according to operations of the client device and desired operations of the agent in obtaining additional usage indicia. The step 606, thus, accumulates usage indicia for the client device over a period of time.

At periodic intervals, the agent performs a step 610 of pushing the usage indicia or data to an administrator, for example, via network communications between the client device and the administrator. The step 610 is repeated in a step of delaying 612, for example, on the order of once a day or other scheduling, in order that the administrator is pushed the accumulated usage indicia for the client device. The administrator can receive the accumulated usage indicia and perform analysis, manipulation and other handling of the data.

Additionally, inputs to the steps 604, 606, 610 can be delivered to the agent from the administrator or other source, including via networked communications between the client device and the administrator. The inputs can include steps of setting 614 parameters for operations of the agent and the client device, for example, including timing of the steps 608 and 612, as well as other control and operational signals and inputs. Moreover, input to the step 610 can also be delivered to the agent from the administrator or other source in similar manner, including, for example, a step of requesting 616. In the step 616, the agent is controlled to then perform the step 610 and push the then-accumulated usage indicia regarding the client device to the administrator or otherwise.

Numerous alternatives and variations are possible in the foregoing systems and method. In certain alternatives, timing synchronization for operations of the agent can be critical. For example, individual client devices operating the agent can have divergent time clocks and timing from the applicable administrator(s) for the client devices. In operations of the systems and methods, therefore, the client device clock is employed by the agent when caching usage indicia. Therefore, when a push to the administrator is initialized at the client device, a data indicative of the timing at the client device clock and as applicable to the usage indicia is also communicated between the client device and the administrator. Appropriate time offsets are, then, determined by the administrator (or, otherwise, by and via the client device prior to the push) in order to synchronize collection results for usage data by the administrator.

Further additions and alternatives can include a wide variety of reporting and analysis of respective usage data of the client device. For example, any database of usage data can sort and summarize usage data of individual and multiple ones of the client devices. Moreover, the database, or other applications and operations of servers and administrators (as well as client devices) can tie usage data to other network communications features and applications, such as, for example, help-desk or other operations and elements. Such ties can also effect operations of updating and security, for example, updates of applications can be pushed or caused to be pushed by the administrator (and/or server or database) to respective client devices. Of course, numerous other possibilities and options are possible and will be understood and appreciated by those skilled in the art as facilitated in implementation and use by virtue of collected usage data.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention.

Benefits, other advantages, and solutions to problems have been described above with regard to specific embodiments. However, the benefits, advantages, solutions to problems and any element(s) that may cause any benefit, advantage, or solution to occur or become more pronounced are not to be construed as a critical, required, or essential feature or element of any or all the claims. As used herein, the terms “comprises, “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A system for collecting use data of a device, comprising:
an agent of the device;
an administrator for the device; and
a network communicatively connected to the agent and the administrator, wherein the agent communicates the use data of the device to the administrator over the network.

2. The system of claim 1, wherein the device comprises:
an operating system; and
wherein the agent comprises:
a hook to the operating system.

3. The system of claim 2, wherein the device comprises:
an application operating in conjunction with the operating system; and
the hook obtains the use data from the operating system.

4. The system of claim 3, wherein the device comprises:
a cache; and
wherein the agent and the operating system share access to the cache.

5. The system of claim 4, wherein the hook causes the operating system to save the use data in the cache, and the agent accesses the use data from the cache.

6. The system of claim 5, wherein the agent further comprises:
a logger for accumulating the use data from the cache over an interval; and
a pusher for communicating the use data as accumulated by the logger on the network at distinct times.

7. The system of claim 7, wherein the pusher is also operable in response to communications from the administrator to communicate the use data as accumulated by the logger on the network at a time selected by the administrator.

8. A system for collecting usage data, comprising:
a client;
a server;
an administrator; and
a communications network communicatively connected to and between the client, the server and the administrator.

9. The system of claim 8, further comprising:
an agent of the client;
wherein the agent hooks an operating system of the client and delivers the usage data to the administrator over the network.

10. The system of claim 9, wherein the client further comprises a cache and the agent accesses the cache for the usage data.

11. A method of collecting use data for a client device, for communications to an administrator device over a network, comprising the steps of:
hooking an operating system of the client device to obtain a first use data; and
pushing the first use data to the administrator device by communication over the network.

12. The method of claim 11, further comprising the steps of:
obtaining a second use data by the step of hooking; and
delivering the second use data, together with the first use data, to the administrator device via the step of pushing.

13. The method of claim 12, further comprising the steps of:
saving the first use data from the step of hooking in a cache of the client device; and accessing the cache to communicate the first use data in the step of pushing.

14. The method of claim 13, further comprising the step of:
logging the first use data in a log of the client device; and
saving the second use data from the step of hooking a the cache.

15. The method of claim 14, further comprising the step of:
logging the second use data in accumulation with the first use data in the log of the client device; and
communicating both the first use data and the second use data of the log of the client device in the step of pushing.

16. The method of claim 15, further comprising the step of:
receiving an input to initiate the step of pushing.

17. The method of claim 16, further comprising the step of:
manipulating the first use data and the second use data by the administrator.
